(19) United States
(12) Patent Application Publication
(10) Pub. No.: US 2009/0140596 A1
(43) Pub. Date: Jun. 4, 2009

(54) METHODS AND APPARATUS FOR A BAR-WOUND STATOR WITH PARALLEL CONNECTIONS

(75) Inventors: EDWARD L. KAISER, ORION, MI (US); KHWAJA M. RAHMAN, TROY, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/323,906

(22) Filed: Nov. 26, 2008

Related U.S. Application Data
(60) Provisional application No. 60/991,306, filed on Nov. 30, 2007.

(51) Int. Cl. H02K 3/12; H02K 15/085

(52) U.S. Cl. 310/201; 29/596; 903/906

(57) ABSTRACT

A bar-wound stator design with parallel connections is characterized by a shorter end turn length as compared to conventional stranded winding. The stator includes an inner winding set and an outer winding set provided within a plurality of slots, wherein the inner winding set is parallel to the outer winding set, and each winding set comprises multiple phases; and wherein the inner winding set and the outer winding set are staggered one slot within the plurality of slots.

### CROSS-REFERENCE

The present application claims priority to U.S. Provisional Pat. App. No. 60/991,306, filed Nov. 29, 2007.

### TECHNICAL FIELD

The present invention generally relates to electrical motors such as those used in connection with hybrid vehicles, and more particularly relates to a bar-wound stator with parallel connections.

### BACKGROUND

Traditional distributed motor windings use multiple turns of round wire and connections to achieve the desired connectivity. With these machines, the final windings and connections are typically formed by a press-die to produce the final shaped end-turns of the motor. This type of design is unsatisfactory in a number of respects. For example, such designs typically show decreased thermal performance, increased axial length, and lower slot fill.

In contrast, the use of hairpin or bar-wound construction in stators results in superior thermal performance as compared to stranded wire due to its larger end-turn surface area. However, the shorter end-turn length of the bar-wound stator increases the active stack length of the machine when the total length is limited.

Accordingly, it is desirable to provide improved bar-wound stator designs that are compact, manufacturable, and exhibit improved thermal performance. Other desirable features and characteristics of the present invention will become apparent from the subsequent detailed description and the appended claims, taken in conjunction with the accompanying drawings and the foregoing technical field and background.

### SUMMARY

A bar-wound stator design with parallel connections is characterized by a shorter end turn length as compared to conventional stranded winding. In one embodiment, the stator includes an inner winding set and an outer winding set provided within a plurality of slots, wherein the inner winding set is parallel to the outer winding set, each winding set comprises multiple phases, and the inner winding set and the outer winding set are staggered one slot.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 depicts exemplary connections on the lead side of the exemplary stator;

FIGS. 2-4 depict stator wiring diagrams in accordance with one embodiment; and

FIG. 5 illustrates a conceptual slot layout in accordance with one winding configuration.

### DETAILED DESCRIPTION

The following detailed description is merely illustrative in nature and is not intended to limit the invention or the application and uses of the invention. Furthermore, there is no intention to be bound by any expressed or implied theory presented in the preceding technical field, background, brief summary or the following detailed description. The invention may be described herein in terms of functional and/or logical block components and various processing steps. It should be appreciated that such block components may be realized by any number of hardware, software, and/or firmware components configured to perform the specified functions. For the purposes of conciseness, conventional techniques and systems related to electrical motors, stators, windings, magnetism, and the like will not be described herein.

In general, the present invention relates to an improved winding scheme for a bar-wound stator in an electrical motor other such machine. In general, the bar wound stator has shorter end turn length as compared to conventional stranded winding.

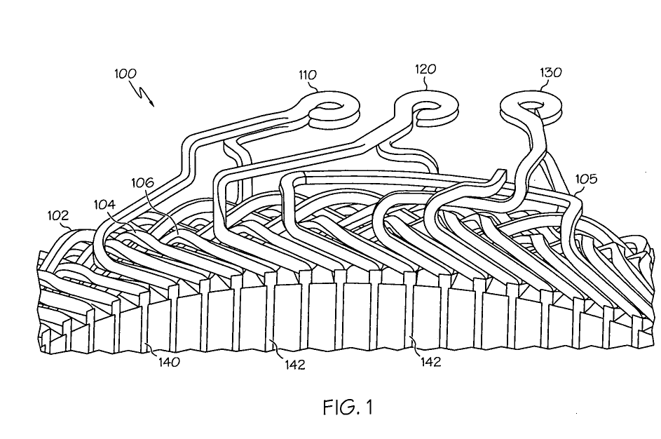

FIG. 1 is a view of exemplary connections on the lead side of a stator in accordance with the present invention. As shown, winding 100 comprises four-layers, wherein each slot (e.g., slots 3, 7, and 11) includes four conductors each. The layers are numbered with the conductors closest to the stator inner diameter (ID) on layer 1, such that the conductor closest to the stator outer diameter (OD) corresponds to layer 4.

Winding 100 utilizes six common jumpers 102 that connect layers 2 and 3 of the winding (not all of which are illustrated in FIG. 1). To allow for neutral jumper connections, these layers are designed to terminate on layers 1 and 4, allowing the neutral connection (105) to be placed on the stator OD and ID where it will not increase the overall stator length.

Connections to phase U (110), phase V (120), and phase W (130) are also illustrated in FIG. 1. As is known, the conductors in the slots of a bar wound stator are formed by inserting hairpins in each slot. After insertion, the hair-pin legs are bent outward to form allow connection from one hair pin to another by welding. This way, the bar-wound stator winding is formed in a wave winding pattern.

Typically, a conventional stranded version of the stator of the present invention would require a 35-40 mm long end-turn length for semi-automated machine winding. Such a long end-turn length limits the available active stack length needed for torque production. The shorter end-turn length of the bar wound stator increases the active stack length of the machine when the total length is limited. However, as mentioned previously, due to the nature of the bar wound stator construction, there is a need for compact connections between layers and phases.

An increase in stator length generally reduces machine performance by requiring a reduction in stator stack length. However, the configuration of winding 100 is such that the phase leads from layers 1 and 4 allow flexibility in reaching the appropriate electrical connection points.

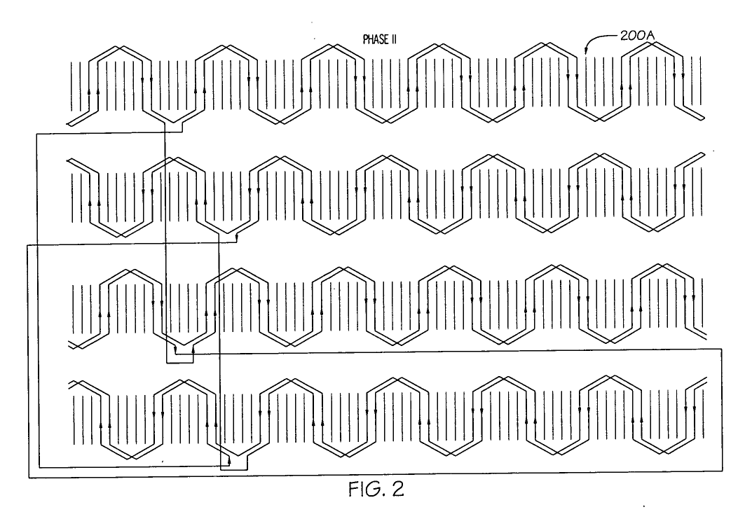

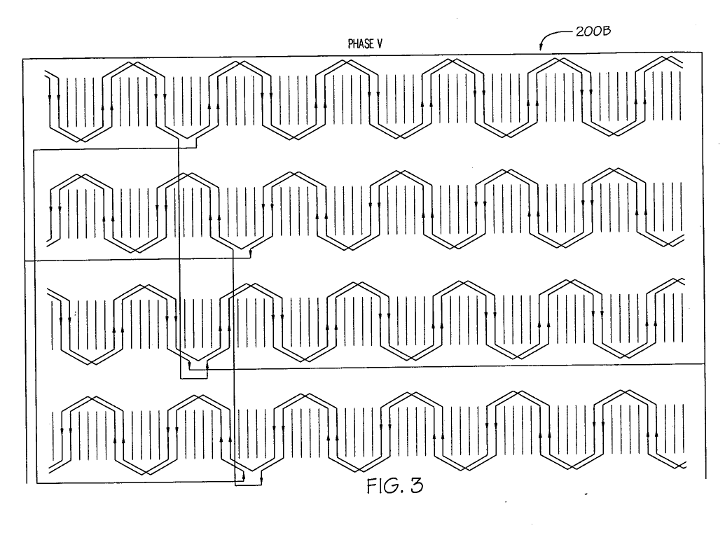

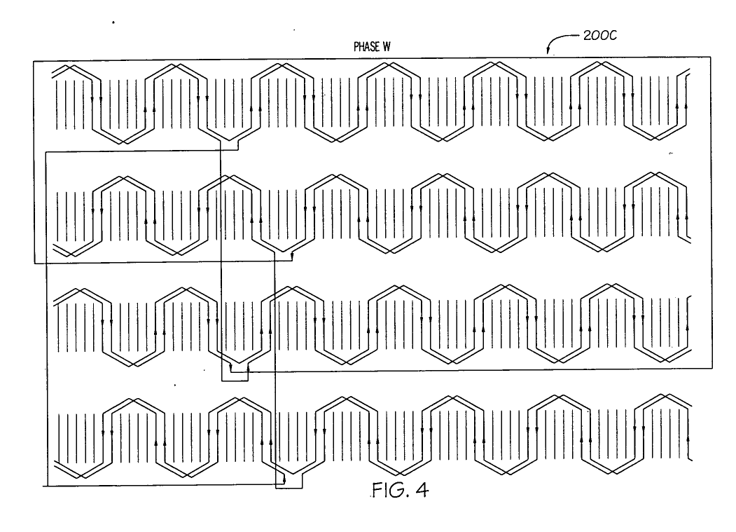

A winding diagram for an exemplary embodiment is shown in FIGS. 3-5. Phase U (200A) is illustrated in FIG. 2, phase V (200B) is illustrated in FIG. 3, and phase W (200C) is illustrated in FIG. 4. The winding configuration illustrated comprises a majority of full-pitch hairpins (104 in FIG. 1) to establish the basic wave winding pattern. Each phase of each parallel winding uses two short pitch hairpins (106 in FIG. 1) to form the adjacent wave pattern around the circumference of the stator. This results in the same phase being located in adjacent slots.

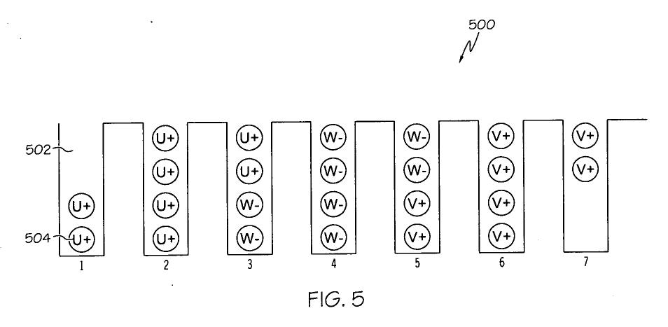

In general, the configuration of winding 100 creates a one-slot stagger as illustrated conceptually in FIG. 5. Configuration 500 includes windings 504 labeled with their corresponding phases (U, V, W, each having + or − designations) in a number of slots. The result is that the phases in layers 4 and 3 are shifted one slot in relation to phases in layer 1 and 2.

The illustrated embodiment provides a winding configuration 100 that achieves parallel connected winding sets and one-slot stagger between the inner winding set and the outer winding set. Further, all phase leads, neutral, and jumper connections are on the stator end opposite the weld end. In addition, the design features identical layer to layer jumpers, and a winding configuration that utilizes both full and short pitch hairpins. The result is a motor stator with short end turn length and compact electrical connections. With no phase leads, neutral connections, or jumpers on the weld end, the stator is easier to manufacture with higher quality

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention and the legal equivalents thereof.

What is claimed is:

1. A bar wound stator comprising:
an inner winding set and an outer winding set provided within a plurality of slots,
wherein the inner winding set is parallel to the outer winding set, and each winding set comprises multiple phases; and
wherein the inner winding set and the outer winding set are staggered one slot within the plurality of slots.

2. The bar wound stator of claim 1, wherein each of the inner and outer winding sets includes a plurality of full-pitch hairpins, and each phase of each winding set includes at least two short pitch hairpins.

3. The bar wound stator of claim 2, wherein each winding set includes exactly two short pitch hairpins.

4. The bar wound stator of claim 1, wherein the bar wound stator has a stator end and a weld end, further including a plurality of jumper connections, a plurality of phase leads, and a neutral connection all located at the stator end.

5. The bar wound stator of claim 1, wherein the winding is characterized by four layers within each slot.

6. The bar wound stator of claim 1, wherein the multiple phases comprises three phases.

7. A method of manufacturing an interior permanent magnet machine, the method comprising:
providing a stator having a plurality of slots;
providing an inner winding set and an outer winding set within the plurality of slots such that the inner winding set is parallel to the outer winding set, each winding set comprises multiple phases, and the inner winding set and the outer winding set are staggered one slot within the plurality of slots; and
placing the stator in magnetic interaction with a rotor.

8. The method of claim 7, wherein each of the inner and outer winding sets includes a plurality of full-pitch hairpins, and each phase of each winding set includes at least two short pitch hairpins.

9. The method of claim 7, wherein each winding set includes exactly two short pitch hairpins.

10. The method of claim 7, wherein the bar wound stator has a stator end and a weld end, further including a plurality of jumper connections, a plurality of phase leads, and a neutral connection all located at the stator end.

11. The method of claim 7, wherein the winding is characterized by four layers within each slot.

12. The method of claim 7, wherein the multiple phases comprises three phases.

13. A traction motor configured to be used in connection with a vehicle, the traction motor comprising a rotor and a stator in magnetic interaction with each other, wherein the stator comprises a plurality of parallel windings within a plurality of slots carrying a plurality of phases, and wherein at least one of the windings is staggered one slot with respect to a second winding.

14. The traction motor of claim 13, wherein each of the inner and outer winding sets includes a plurality of full-pitch hairpins, and each phase of each winding set includes at least two short pitch hairpins.

15. The traction motor of claim 14, wherein each winding set includes exactly two short pitch hairpins.

16. The traction motor of claim 13, wherein the bar wound stator has a stator end and a weld end, further including a plurality of jumper connections, a plurality of phase leads, and a neutral connection all located at the stator end.

17. The traction motor of claim 13, wherein the winding is characterized by four layers within each slot.

18. The traction motor of claim 13, wherein the multiple phases comprises three phases.

19. The traction motor of claim 13, wherein:
the multiple phases comprises three phases;
there are four layers designated layer 1, layer 2, layer 3, and layer 4 within each slot; and
layers 4 and 3 are shifted one slot with respect to layers 1 and 2.

20. The traction motor of claim 19, wherein layers 2 and 3 are connected by a plurality of jumpers.
